(19) United States
(12) Patent Application Publication
(10) Pub. No.: US 2022/0080241 A1
(43) Pub. Date: Mar. 17, 2022

(54) Inertizing Method And Inertizing Installation, In Particular For The Avoidance Of Fire

(71) Applicant: Wagner Group GmbH, Langenhagen (DE)

(72) Inventor: Marc Vroemen, Langenhagen (DE)

(21) Appl. No.: 17/276,587

(22) PCT Filed: Sep. 17, 2019
(86) PCT No.: PCT/EP2019/074777

§ 371 Date: Dec. 6, 2021

(30) Foreign Application Priority Data
Sep. 19, 2018 (EP) 18020452.1

(51) Int. Cl. A62C 99/00; B01D 53/047; B01D 53/22; B01D 53/26

(52) U.S. Cl. CPC A62C 99/0018; B01D 53/047; B01D 53/22; B01D 53/265; B01D 2257/80; B01D 2253/108; B01D 2256/10; B01D 2257/104; B01D 2253/102

(57) ABSTRACT

An inertizing method for the avoidance of fire. An inert or poorly-flammable product gas flow (161) is produced starting from a gas mixture flow (141), which contains one reactive gas and one inert gas. The gas mixture flow (141) is supplied to a gas separation unit (110, 120, 410) under pressure and the reactive gas is at least partially separated from the gas mixture flow (141). Gas components which are not separated are removed as a product gas flow (161) and the reactive gas components separated from the gas mixture flow (141) are removed as a secondary product gas flow (151). The removed product gas flow (161) is introduced into a vortex tube (200) and is separated into a hot product gas partial flow (163) and a cold product gas partial flow (162), and the hot and/or the cold product gas partial flow (162, 163) is introduced into an environment (300).

### BACKGROUND OF THE INVENTION

The invention relates to an inertizing method, in particular for the avoidance of fire, wherein an inert, in particular poorly-flammable product gas flow, is produced starting from a gas mixture flow, which gas mixture flow contains at least one reactive gas component, i.e., a reactive, in particular easily-flammable volume component, and an inert gas component, i.e., an inert, in particular poorly-flammable volume component, each in relation to the total volume of the gas mixture flow. The gas mixture flow is supplied to at least one gas separation unit with application of pressure and the reactive gas component is at least partially separated from the gas mixture flow by means of a separating means. Gas components which are not separated and/or not separable from the gas mixture flow are taken from the at least one gas separation unit as the product gas flow. The reactive gas components separated from the gas mixture flow are removed from the at least one gas separation unit as a secondary product gas flow.

Furthermore, the invention relates to an inertizing installation (also referred to as an oxygen reduction installation) for producing and providing an inert, in particular poorly-flammable product gas flow, in particular for carrying out an inertizing method according to the invention. The inertizing installation comprises one or more gas separation units, which each have a line connection and are fluidically connectable to a gas mixture line for supplying a gas mixture flow. The gas mixture flow contains at least one reactive gas component and one inert gas component. The one or more gas separation units have a separating means suitable for separating the reactive gas component from the gas mixture flow and can be pressurized to separate the reactive gas component from the gas mixture flow. Furthermore, the one or more gas separation units have a line connection and are fluidically connectable to a product gas line for removing a product gas flow and to a secondary product gas line for removing a secondary product gas flow. The product gas flow contains the gas components which are not separated and/or not separable from the gas mixture flow, the secondary product gas flow contains the reactive gas components separated from the gas mixture flow.

Finally, the invention relates to the use of an inertizing installation, in particular an inertizing installation according to the invention, for inertizing a refrigerated environment, wherein the inertizing installation has one or more gas separation units, which have a line connection to a product gas line for removing the product gas flow, for producing and providing an inert, in particular poorly-flammable product gas flow, in particular for carrying out an inertizing method according to the invention.

Gas separation methods and associated gas separation installations are used in a broad technical field for separating gas mixtures, i.e., for breaking down the gas mixtures into their individual components. Different physical properties of the individual gas components are typically utilized for this purpose. Gas mixtures may thus be broken down due to different molecular sizes of the individual gases in the membrane method or due to their different boiling points in the gas liquefaction and separation according to Linde.

A gas liquefaction method in which the gas is compressed by means of compressors to a high pressure and subsequently cooled to a sufficiently low temperature in order to partially liquefy it and subsequently separate it by expansion is known, for example, from U.S. Pat. No. 3,775,998. The gas liquefaction described herein is based on the Ranque effect and is achieved by means of a vortex tube. The gas flow already compressed to a high pressure is introduced tangentially into the cylindrical vortex tube and set into rapid rotation, wherein the radially outer region of the swirled gas flow has a higher temperature than the radially inner region. A gas flow of higher temperature and a gas flow of lower temperature may thus be removed at the respective axial ends of the vortex tube. At the same time, a part of the introduced gas is condensed, i.e., liquefied. The disclosed vortex tube is accordingly suitable for separating a gas mixture, for example, air can be broken down by liquefaction into its individual components in order to obtain oxygen as the product gas and nitrogen as a secondary product.

In inertizing or oxygen reducing methods, in contrast, nitrogen is produced as a product gas and oxygen as a secondary product. Known exemplary applications in which the separated nitrogen proportion is used are, for example, so-called hypoxia training, in which the oxygen content in an enclosed space is reduced by introducing nitrogen-enriched air to produce artificial elevation conditions, or an oxygen-poor storage of foods under a controlled atmosphere (CA), in which, inter alia, the percentage proportion of air oxygen is regulated in order to slow the aging process of easily spoiled products.

In particular in the field of fire protection, inter alia, gas separation methods have become widespread for the avoidance of fire and for fighting fire by inertizing, which are based either on different adsorption properties or on differences caused by molecular size of the diffusion speeds of the components contained in the gas mixture. For example, oxygen as a reactive and easily-flammable gas component can be separated from supplied ambient air by means of adsorption on an adsorbent or by means of diffusion through a membrane and the remaining nitrogen can be supplied as an inert and poorly-flammable gas component to an environment, i.e., a protected region or enclosed space. In general, materials having a low reactivity under predetermined ambient conditions are referred to as inert. Thus, for example, nitrogen is inert and poorly flammable under normal conditions, while in contrast oxygen has a high reactivity, i.e., is reactive, in particular easily flammable. Due to the supply of nitrogen, the nitrogen/oxygen ratio of the ambient air present in the environment increases, which is approximately 78 vol. % nitrogen and 21 vol. % oxygen under normal conditions. In general, the oxygen content is lowered to a value between 15-17 vol. % and in exceptional cases even to a value between 12-14 vol. % for inertizing an environment and thus for the avoidance of fires. At such a lowered oxygen content, most combustible materials can no longer ignite. At the same time, the atmosphere is harmless to humans and animals as long as longer stays within the inertizing environment are avoided. The use of an inert product gas as a protective gas for inertizing an environment or of enclosed spaces is therefore usually made use of to prevent fires and to fight fires in the EDP field in electrical switch and distributor rooms and in storage areas having high-value economic goods, but also in the storage area for deep-frozen products. In the meaning of the present application, the term “environment” is understood in particular as a space and/or region fundamentally accessible and/or traversable for persons. Examples of such an environment are: factory halls, storage spaces, archive spaces, server rooms, deep-freeze warehouses, etc.

To provide the protective gas required for the inertizing, for example, an inert, in particular poorly-flammable product gas is produced by means of the gas separation method based on adsorption. For this purpose, the gas mixture, expediently ambient air, is supplied to an adsorption unit. The adsorption unit is embodied as a container, in particular a fixed bed reactor, and contains the absorbent, which can be, for example, zeolite or activated carbon. To initiate the adsorption phase, in which the reactive, in particular easily-flammable gas component oxygen is adsorbed and the remaining inert, in particular poorly-flammable gas components, especially nitrogen, are removed, the ambient air is supplied under pressure to the adsorption unit. To initiate the desorption phase, sometimes also called the regeneration phase, in which the adsorbed oxygen desorbs to regenerate the adsorbent and is removed from the adsorption unit, the pressure applied therein is lowered back to ambient pressure or below it. Although installations having a single adsorption unit, which alternately absorbs and desorbs with the aid of a buffer container or temporary store, are certainly known from the prior art for carrying out a gas separation method based on adsorption, a method control using two adsorption units, so-called pressure swing adsorption, has proven to be expedient.

An inertizing installation having a gas separation system for providing nitrogen while carrying out a pressure swing adsorption is disclosed in EP 2 801 392 B1. In this case, ambient air under pressure is applied alternately to two adsorption containers, wherein the oxygen adsorbs on the adsorbent contained therein and nitrogen-enriched air is removed. As soon the adsorbent is saturated, a switch is made to the other container and the previous adsorption container is regenerated by pressure reduction and venting. The adsorption units pass through an adsorption phase and a desorption or regeneration phase in cycles. To optimize the efficiency of the gas separation system, it is advantageous if the starting gas mixture is supplied at a temperature of 15° C. to 25° C. The adsorption is moreover an exothermic process, so that the nitrogen used for inertizing usually has a temperature above the typical ambient temperature, which is often specified to be between 20° C. and 25° C. This is disadvantageous in the inertizing of a refrigerated environment, i.e., an environment provided for refrigeration, the temperature of which is below the typical ambient temperature, for example a server room, or the temperature of which is even below the freezing point, for example a deep-freeze warehouse, which is expediently operated at 18° C. or lower. Upon introduction of the warmer inert gas, in particular nitrogen, into the colder environment, additional energy is therefore necessary to apply the required cooling power. During the desorption or regeneration phase, the oxygen contained in the adsorbent desorbs and can be removed from the respective adsorption unit. According to pressure equipment guideline 2014/68/EU, oxygen-conducting lines are considered to be hazardous and oxidizing and are therefore subject to special protective regulations, whereby in turn increased costs result for the corresponding gas lines for the discharge of oxygen-enriched air.

One object of the present invention is therefore to specify an inertizing method improved over the prior art and an improved inertizing installation for producing and providing an inert, in particular poorly-flammable product gas flow, which enables more efficient inertizing of a temperature-controlled environment and provides additional usage options of the product gas flow.

The object is achieved according to the invention by an inertizing method according to claim 1, an inertizing installation according to claim 9, and the use of an inertizing installation according to claim 15.

### SUMMARY OF THE INVENTION

An inertizing method according to the invention of the type described in greater detail at the outset, in which a reactive gas component is reactive under predetermined ambient conditions present in the environment and an inert gas component is inert under the predetermined ambient conditions, is distinguished in that the product gas flow removed from the at least one gas separation unit is introduced into a vortex tube, is divided and/or separated within the vortex tube into a hot product gas partial flow and a cold product gas partial flow, and the hot and/or the cold product gas flow is or are introduced completely or partially and/or temporarily into an environment, in particular a space and/or region fundamentally accessible and/or traversable to persons, preferably a factory hall, a storage space, an archive space, a server room, a deep-freeze warehouse, or the like.

According to the invention, it is thus provided that the product gas flow removed from the at least one gas separation unit is temperature controlled or cooled or heated by means of a vortex tube in that the product gas flow is introduced, preferably radially or tangentially, via a gas inlet into a vortex tube and divided therein into a hot and a cold product gas partial flow. The hot product gas partial flow can be removed at an axially arranged hot gas outlet of the vortex tube and is warmer, thus has a higher temperature, than the product gas flow introduced into the vortex tube. The cold product gas partial flow is removed at a cold gas outlet axially opposite to the hot gas outlet and is colder, thus has a lower temperature, than the product gas flow introduced into the vortex tube. The hot product gas partial flow is thus also warmer than the cold product gas partial flow, while in contrast the cold product gas partial flow is colder than the hot product gas partial flow.

The removed product gas flow preferably has an inert gas component increased over the gas mixed flow and the removed secondary product gas flow has a reactive gas component increased over the gas mixed flow. For inertizing the environment, which can be, for example, an enclosed space, a protected region, or the like, the inert, in particular poorly-flammable product gas flow is introduced optionally and as needed in the form of the hot and/or the cold product gas partial flow into the environment, whereby a reactive gas component, in particular an oxygen proportion, present in the environment is reduced. Depending on the degree of inertizing of the environment or depending on the existing oxygen content, it is also conceivable not to introduce any product gas flow at all into the environment temporarily, i.e., neither the hot nor the cold product gas partial flow, for example, so as not to fall below a predetermined oxygen minimum level. Of course, it is also provided that both product gas partial flows be supplied to the environment at least temporarily, whereby faster inertizing can be carried out especially at the beginning of the inertizing process.

To divide the product gas flow into the hot product gas partial flow and the cold product gas partial flow, a vortex tube is arranged in a product gas line, between a product gas outlet of the at least one gas separation unit, the adsorption unit, and the environment. The temperature of the hot product gas partial flow and/or the temperature of the cold product gas partial flow preferably corresponds to the temperature present in the environment, so that the introduction of the respective product gas partial flow does not change the temperature of the environment. The temperature of the hot product gas partial flow is advantageously above and/or the temperature of the cold product gas partial flow is advantageously below the temperature present in the environment, so that a corresponding temperature control of the environment is assisted by introducing the respective product gas partial flow or a regulation of the ambient temperature is possible. In relation to known inertizing methods, the inert, in particular poorly-flammable product gas flow provided for inertizing can be introduced into the environment with a temperature corresponding to the existing ambient temperature or even can optionally contribute to cooling or heating the environment. In this way, energy otherwise required for heating or cooling the environment can be saved, whereby the inertizing method according to the invention has a higher efficiency and is thus more cost-effective.

Further examples of the application of the inertizing method according to the invention are, for example, the hypoxia training mentioned at the outset or the oxygen-poor storage of easily spoiling foods.

The inertizing method according to the invention is fundamentally applicable to all method suitable for separating gas mixtures, however, the invention is to be explained in greater detail hereinafter first on the basis of an adsorption method and subsequently on the basis of a membrane method, which have proven to be particularly expedient.

In an adsorption method, the separation of the gas mixture flow takes place in two chronologically successive phases, an adsorption phase and a desorption phase, sometimes also referred to as a regeneration phase. In the adsorption phase, the gas mixture flow is supplied to at least one gas separation unit, in this case an adsorption unit, with application of pressure and the reactive gas component is at least partially separated by means of the separating means. An adsorbent contained in the least one adsorption unit, on which the reactive gas component at least partially adsorbs, is used here as the separating means. The gas components of the gas mixture flow which are not adsorbed and/or not adsorbent in the adsorption phase are removed from the at least one adsorption unit as the product gas flow. In the desorption phase, the adsorbed reactive gas components are desorbed from the adsorbent under pressure reduction and removed from the at least one adsorption unit as a secondary product gas flow.

In one refinement of this expedient application of the method according to the invention, the adsorption phase and the desorption and/or regeneration phase are carried out at the same time in parallel within at least one respective adsorption unit.

In this so-called pressure swing adsorption, cyclic switching takes place between the adsorption phase and the desorption and/or regeneration phase within an adsorption unit. Two adsorption units connected in parallel are typically used, so that alternately a first adsorption unit passes through an absorption phase, while the second adsorption unit is in the desorption and/or regeneration phase. After carrying out a pressure change, for example, via control valves, the second adsorption unit is then in the absorption phase and the first adsorption unit passes through the desorption and/or regeneration phase. In this case, the gas mixture flow is alternately supplied to the first or the second adsorption unit passing through the adsorption phase under pressure application for at least partial adsorption of the reactive gas component, and the product gas flow is alternately removed from this unit, and the secondary product gas flow is removed under pressure reduction alternately from the respective other first or second adsorption unit in the desorption phase. In this way, a continuous product gas flow and secondary product gas flow can be ensured even without buffer containers.

In one refinement of this variant, a pressure equalization phase is preferably carried out between each change of the adsorption phase and the desorption and/or regeneration phase.

To carry out the pressure equalization phase, the first adsorption unit and the second adsorption unit are fluidically connected to one another, wherein the gas mixture flow flows or circulates between the first adsorption unit and the second adsorption unit to equalize the pressure applied within the first adsorption unit and within the second adsorption unit. To fluidically connect the two adsorption units to one another, already existing line connections extending directly between the two adsorption units are opened, for example, via control valves, whereas supply and discharge lines, such as the gas mixture line, the product gas line, and/or the secondary product gas line are disconnected, preferably also via control valves, so that they are no longer fluidically connected to the adsorption units. The pressure equalization phase is automatically initiated by such a switch or changeover, in that the pressure difference between the two adsorption units indicates an automatic flow from the adsorption unit having higher pressure to the adsorption unit having lower pressure.

The membrane method, which is also suitable for carrying out the inertizing method according to the invention, essentially differs from the above-described (pressure swing) adsorption method in that the separation of the gas mixture flow takes place continuously, i.e., independently of chronologically successive phases. The separation principle is based here on the different molecular sizes of the individual components of the gas mixture flow. A membrane is used here as the separating means, wherein gas components having a smaller molecular size have a higher diffusion speed, i.e., diffuse faster through the membrane, than gas components having a higher molecular size, which accordingly diffuse slower or not at all through the membrane.

The gas mixture flow is supplied to at least one gas separation unit, in this case a membrane module, with application of pressure and the reactive gas component is at least partially separated by means of a separating means. A membrane contained in the at least one membrane module, through which the reactive gas component diffuses, i.e., is separated from the gas mixture flow, is used here as the separating means. Gas components of the gas mixture flow which are not diffused and/or not diffusing are removed from the at least one membrane module as a product gas flow. The diffused reactive gas component separated from the gas mixture flow is removed from the at least one membrane module as a secondary product gas flow.

The advantageous embodiments of the method according to the invention described hereinafter are each applicable for arbitrary gas separation methods and are expediently carried out in an adsorption method and/or a membrane method.

According to one advantageous method variant, the cold product gas partial flow is introduced completely or partially and/or temporarily into the environment, wherein the environment is inertized by means of the cold product gas partial flow and the cold product gas partial flow simultaneously contributes to cooling the environment.

It is thus preferably provided that the cold product gas partial flow or at least a part of the cold product gas partial flow is introduced into the environment as needed for inertizing and simultaneous cooling. In particular only, i.e., exclusively the cold product gas partial flow can be supplied to the environment, wherein the atmosphere present in the environment is (partially) replaced or displaced by the cold component of the inert, in particular poorly-flammable product gas flow. Such a method control is especially suitable for inertizing refrigerated environments, the temperature of which is below a typical ambient temperature. Depending on the temperature of the refrigerated environment and the cold product gas partial flow, actual cooling thus takes place if the temperature of the cold product gas partial flow is below the temperature of the refrigerated varmint, or at least less heating, if the temperature of the cold product gas partial flow is above the temperature of the refrigerated environment. In both variants, the energy required for cooling the refrigerated environment, for example a deep-freeze warehouse, can be saved by supplying refrigerated, inert, in particular poorly-flammable product gas in the form of the cold product gas partial flow. If there is no present need for cooling or inertizing, introducing the cold product gas partial flow into the environment can also be completely dispensed with, at least temporarily.

According to an alternative or optional method control, the hot product gas partial flow is completely or partially and/or temporarily introduced into the secondary product gas flow taken from at least one gas separation unit, in particular during the desorption phase.

Optionally or alternatively, it can thus be provided that the hot product gas partial flow or at least a part of the hot product gas partial flow is introduced optionally or as needed into the secondary product gas flow. Due to the introduction of the hot product gas partial flow into the secondary product gas flow, it is diluted, i.e., the proportion of reactive, in particular easily-flammable reactive gas, for example oxygen, in relation to the total mass flow is reduced, whereby the oxidizing properties of the oxygen-enriched secondary product gas flow are reduced. In this way, the classification according to pressure equipment guideline 2014/68/EU of the secondary product gas flow can be changed from fluid group 1 (hazardous, oxidizing) to fluid group 2 (harmless). Overall, the demands on the line system provided for guiding the secondary product gas flow or the devices provided for storing and/or disposing of the secondary product gas flow can be reduced. The introduction of the hot product gas partial flow into the secondary product gas flow is therefore to take place as immediately as possible after removal of the secondary product gas flow from the secondary product gas flow from the gas separation unit, in particular adsorption unit or membrane module, which is in particular in the desorption and/or regeneration phase. For the case in which the secondary product gas flow having high oxygen proportion is required, for example, for further use in other processes, introducing the hot product gas partial flow into the secondary product gas flow can be omitted, at least temporarily, also completely.

It is particularly advantageous to use the cold product gas partial flow removed from the cold gas outlet of the vortex tube for cooling a refrigerated environment and simultaneously using the hot product gas partial flow removed from the hot gas outlet for diluting the secondary product gas flow. This enables particularly efficient method control, whereby the cost savings in relation to known inertizing methods and installations can be maximized.

The hot product gas partial flow can also optionally or alternatively be supplied completely or partially and/or temporarily to at least one gas separation unit, in particular adsorption unit.

It is also preferably provided that the hot product gas partial flow or at least a part of the hot product gas partial flow is supplied as needed to at least one adsorption unit directly or indirectly as part of the inflowing or circulating gas mixture flow, preferably during the pressure equalization phase. In particular during the desorption and/or regeneration phase, the thermal energy contained in the hot product gas partial flow contributes to the regeneration of the adsorbent arranged in the corresponding adsorption unit or the adsorbed reactive gas component is desorbed faster and/or more thoroughly, i.e., more completely from the adsorbent. At the same time, the hot product gas partial flow introduced into the adsorption unit can also contribute to diluting the removed secondary product gas flow, whereby in turn its oxidizing properties may be reduced and preferably the fluid class may be changed. The introduction of the hot product gas partial flow into the at least one adsorption unit is solely optional, an introduction can also be omitted at least temporarily, also completely.

In a further method variant, which can optionally or alternatively be carried out, the hot product gas partial flow is introduced completely or partially and/or temporarily into the environment, wherein the environment is inertized by means of the hot product gas partial flow and the hot product gas partial flow simultaneously contributes to heating the environment.

Similarly as in the case of cooling of the environment, it is optionally or alternatively provided that the hot product gas partial flow or at least a part of the hot product gas partial flow is introduced optionally or as needed into the environment in order to heat it. The atmosphere present in the environment is (partially) replaced or displaced by the hot component of the inert, in particular poorly-flammable product gas flow, which results in inertizing of the environment, i.e., a reduction of the proportion of reactive gas, in particular oxygen, present in the environment. For the case in which the temperature present in the environment is below the temperature of the hot product gas partial flow, the environment is simultaneously heated by the thermal energy contained in the hot product gas partial flow. If the temperature of the environment is above the temperature of the hot product gas partial flow, the (thermal) energy possibly required for heating the environment and supplied in another way can be reduced.

Finally, in an optional method alternative, the cold product gas partial flow removed from the vortex tube and the hot product gas partial flow removed from the vortex tube can be combined completely or partially to form a mixed product gas flow and this mixed product gas flow can be supplied to an environment, wherein the environment is inertized by means of the mixed product gas flow.

Alternatively, it is also possible to combine the hot product gas partial flow and the cold product gas partial flow after flowing through the vortex tube and then supply the mixed product gas flow thus resulting, the temperature of which is typically below the temperature of the product gas flow before the entry into the vortex tube, to the environment. In that the two product gas partial flows are mixed with one another only partially, in different proportions, for example, a regulation of the desired temperature of the mixed product gas flow can also take place.

The above-described method variants can each be combined with one another, wherein the hot and/or the cold product gas partial flow can each be supplied completely or partially to different or the same installation elements. This can also take place temporarily as needed. For example, it is conceivable to first supply the cold and the hot product gas partial flow, either as individual flows or in the form of a mixed product gas flow, to the environment, in order to shorten the duration of the initial inertizing. Subsequently, after reaching the provided inertizing level, the hot product gas partial flow can be introduced into the secondary product gas flow, for its dilution, while the cold product gas partial flow is still supplied to the environment for maintaining the provided inertizing level and for simultaneous cooling.

In one preferred method variant, the product gas flow is at least partially condensed within the vortex tube and the condensate is separated.

In the case of such gas drying, residual moisture possibly contained in the product gas flow, in particular in the form of water, is condensed out by means of a condensate trap inside the vortex tube and separated as a liquid. The product gas flow subsequently introduced into the environment, consisting of the cold product gas partial flow and/or the hot product gas partial flow, thus has a lower humidity overall, whereby in particular a corrosion of stored products due to excessively high ambient humidity is avoided.

Ambient air is preferably used as a gas mixture flow, wherein the reactive gas component is oxygen and the inert gas component is nitrogen.

The inert, in particular poorly-flammable product gas flow, which is removed in the adsorption phase in particular, then has an increased nitrogen proportion over the gas mixture flow, i.e., the ambient air used, and the reactive, in particular easily-flammable secondary product gas flow, which is removed in the desorption phase in particular, has an increased oxygen proportion over the gas mixture flow, i.e., the ambient air.

An inertizing installation according to the invention of the type described in greater detail at the outset, in which the product gas line has a line connection to an environment, in particular a space and/or region fundamentally accessible and/or traversable to persons, preferably a factory hall, a storage space, an archive space, a server room, a deep-freeze warehouse, or the like, for introducing the product gas flow and a reactive gas component is reactive under predetermined ambient conditions present in the environment and an inert gas component is inert under the predetermined ambient conditions, is distinguished by a vortex tube, which is arranged in the product gas line, wherein the product gas line opens into the vortex tube to introduce the product gas flow removed from the one or the multiple gas separation units, and wherein the vortex tube is designed for temperature-dependent separation and/or division of the product gas flow and has a cold gas outlet for removing and providing a cold product gas partial flow and a hot gas outlet for removing and providing a hot product gas partial flow.

In the scope of the inventive concept, it is thus provided that the product gas outlet of an inertizing installation or the product gas line adjoining the product gas outlet is provided with a vortex tube, into which the product gas flow can preferably be introduced tangentially via a gas inlet. The product gas flow may be divided into a hot product gas partial flow and a cold product gas partial flow within the vortex tube. The vortex tube has a cold gas outlet and a hot gas outlet, preferably arranged axially opposite to one another, to provide and remove the two product gas partial flows. Due to the vortex tube arranged inside the product gas line, the inert, in particular poorly-flammable product gas flow can thus be removed as needed as hot product gas partial flow via the hot gas outlet and/or as cold product gas partial flow via the cold gas outlet and used further. The integration of a vortex tube into the inertizing installation thus expands the possible uses and the areas of application of the product gas flow produced and provided for inertizing.

According to one advantageous embodiment of the inertizing installation according to the invention, the cold gas outlet and/or the hot gas outlet of the vortex tube has a fluidic line connection to an environment or is fluidically connectable to the environment, so that the cold product gas partial flow and/or the hot product gas partial flow can be introduced into the environment for inertizing thereof.

In such an embodiment, a cold gas line can be connected in a switchable and/or controllable manner to the cold gas outlet of the vortex tube, in particular via control valves, and can open into the environment, so that the cold product gas partial flow can be introduced therein at least partially and/or temporarily. A hot gas line can also be connected in a switchable and/or controllable manner to the hot gas outlet of the vortex tube, in particular via control valves, and can open into the environment, so that the hot product gas partial flow can be introduced therein at least partially and/or temporarily. Either the cold gas line or the hot gas line, or even both lines, can thus open into the environment as needed. In this way, the product gas flow, in addition to inertizing the environment, can also be used for its temperature control, as needed for heating, by means of the hot product gas partial flow or for cooling by means of the cold product gas partial flow.

The hot gas outlet of the vortex tube can advantageously also have a line connection and be fluidically connectable to a connecting line of the inertizing installation, so that the hot product gas partial flow can be introduced into the connecting line.

The hot product gas partial flow then contributes as a component of the gas mixture flow to the regeneration of the adsorbent, because the thermal energy transferred directly to the gas mixture flow increases the efficiency of the regeneration or facilitates the desorption. Alternatively, it is also conceivable to introduce the hot product gas partial flow directly into the respective adsorption unit in the desorption and/or regeneration phase. For this purpose, a line connection would be provided in each case between the hot gas outlet and the corresponding adsorption unit.

In a further advantageous embodiment of the inertizing installation according to the invention, the hot gas outlet of the vortex tube can also have a line connection and be fluidically connectable to the secondary product gas line, so that the hot product gas partial flow can be introduced into the secondary product gas line.

As already described, in this way the secondary product gas flow can be diluted, whereby the fluid group classification according to pressure equipment guideline 2014/68/EU of the secondary product gas flow may be changed from fluid group 1 (hazardous, oxidizing) to fluid group 2 (harmless), so that the following peripheral equipment (pipelines, pressurized containers, etc.) is subject to less strict safety regulations and as a result can be provided more cost-effectively. In particular, the secondary product gas line can be designed in this way as a line conveying fluid group 2.

One advantageous embodiment of the inertizing installation provides that the vortex tube has a condensate trap for separating condensate arising during the separation and/or division of the product gas flow.

During the temperature-dependent division of the product gas flow by swirling in the vortex tube, residual moisture contained in the hot product gas partial flow in particular condenses upon contact with the vortex tube inner wall and is deposited thereon. By using a condensate trap, which is designed, for example, as radially arranged outlet openings on the vortex tube inner wall, depositing condensate can be discharged, preferably in the direction of the hot gas outlet. In this way, gas drying of the product gas flow, in particular of the hot product gas partial flow, is enabled. The separated condensate can be discharged via a corresponding condensate line and possibly used further in other applications.

The vortex tube can be equipped according to one advantageous embodiment with setting means for setting the temperature difference between the hot product gas partial flow and the cold product gas partial flow.

For this purpose, an in particular telescopic longitudinal adjustability by position change of an end piece or the use of a regulating valve is conceivable. By using such setting means, the temperature of the cold product gas partial flow removable at the cold gas outlet and of the hot product gas partial flow removable at the hot gas outlet may be regulated or at least pre-regulated to facilitate a temperature control as needed of the environment to be inertized.

A use according to the invention of the type described in greater detail at the outset, in which the inertizing installation is also used for cooling a refrigerated environment, in particular a room and/or region which is refrigerated and/or is to be refrigerated and is fundamentally accessible and/or traversable to persons, preferably a factory hall, a storage space, an archive space, a server room, a deep-freeze warehouse, or the like which is refrigerated and/or is to be refrigerated, and wherein the product gas line has a line connection to the refrigerated environment for introducing the product gas flow, is distinguished in that the product gas flow is introduced into a vortex tube, is divided within the vortex tube into a hot product gas partial flow and a cold product gas partial flow, and subsequently the cold product gas partial flow is introduced completely or partially into the refrigerated environment.

Due to the integration of a vortex tube, the option results as the use according to the invention of producing and providing a cold product gas flow or a cold product gas partial flow which is particularly suitable for inertizing a refrigerated environment, preferably a deep-freeze warehouse. Especially in the storage of deep-frozen foods, the deep-freeze warehouse is cooled down to −18° C. or less, for which a not insignificant energy demand is required to apply the necessary cooling power. By installing a vortex tube, the product gas flow used for inertizing a deep-freeze warehouse can be pre-cooled or its temperature can be reduced without additional energy requirement, for example in the form of electricity, so that the energy requirement necessary for cooling the deep-freeze warehouse is reduced or at best the refrigerated environment, in particular the deep-freeze warehouse, can be cooled exclusively by the cold product gas partial flow. In addition to the use of an inertizing installation having integrated vortex tube, of course, retrofitting existing inertizing installations with a vortex tube is also possible.

Overall, it is provided in the scope of the concept according to the invention that a vortex tube is integrated into an inertizing installation in order to expand the possibilities of an inertizing method and enable a more efficient use of the inertizing installation, in particular for a refrigerated environment.

It is to be noted that the features and measures set forth individually in the preceding and following description can be combined with one another in any technically reasonable manner and disclose further embodiments of the invention. The description additionally characterizes and specifies the invention in particular in conjunction with the figures.

### DESCRIPTION OF THE VIEWS OF THE DRAWINGS

Further advantageous embodiments of the invention are disclosed in the following description of the figures. In the figures

FIG. 1a shows a schematic illustration of an exemplary embodiment of an inertizing installation according to the invention having a vortex tube in an adsorption/desorption phase,

FIG. 1b shows a schematic illustration of an exemplary embodiment of an inertizing installation according to the invention having a vortex tube in a pressure equalization phase,

FIG. 2 shows an enlarged schematic sectional illustration of the vortex tube of the exemplary embodiment of the inertizing installation according to the invention according to FIGS. 1a and 1b,

FIG. 3 shows a schematic illustration of an exemplary embodiment of an inertizing installation according to the invention having a vortex tube for carrying out a first method variant,

FIG. 4 shows a schematic illustration of an exemplary embodiment of an inertizing installation according to the invention having a vortex tube for carrying out a second method variant,

FIG. 5 shows a schematic illustration of an exemplary embodiment of an inertizing installation according to the invention having a vortex tube for carrying out a third method variant, and

FIG. 6 shows a schematic illustration of an exemplary embodiment of an inertizing installation according to the invention for carrying out a membrane method.

In the different figures, the same parts are always provided with the same reference signs, because of which they are generally also only described once.

### DETAILED DESCRIPTION OF THE INVENTION

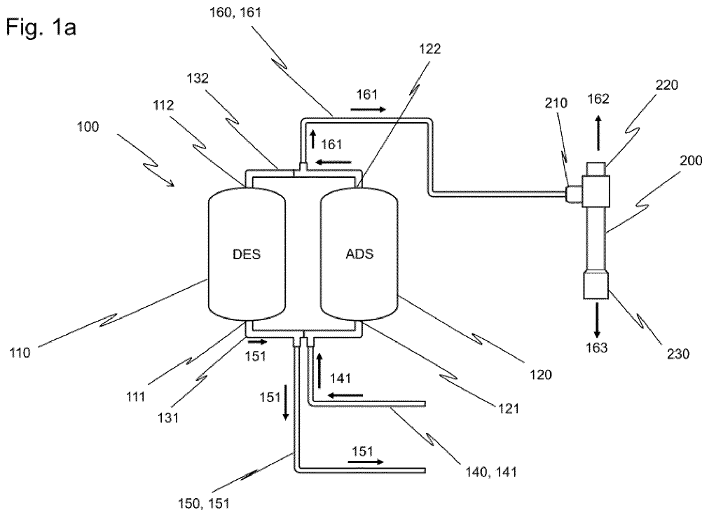

FIG. 1a shows a schematic illustration of an exemplary embodiment of an inertizing installation 100 according to the invention having a vortex tube 200. The inertizing installation 100 is embodied as an installation operating according to a pressure swing adsorption method, also referred to as so-called Pressure Swing Adsorption (PSA) and has a first adsorption unit 110 and a second adsorption unit 120. The adsorption units 110, 120 are preferably embodied as containers, in particular fixed bed reactors, and contain an absorbent, which can be, for example, zeolite or activated carbon. Via a respective first line fitting 111, 121, the adsorption units 110, 120 are each connected to a first connecting line 131 and via a respective second line fitting 112, 122, they are each connected to a second connecting line 132. The first and the second connecting line 131, 132 thus connect the first adsorption unit 110 and the second adsorption unit 120 to one another. A gas mixture line 140 adjoins the first connecting line 131, which is provided for supplying a gas mixture flow 141 alternately to the first adsorption unit 110 or to the second adsorption unit 120. Furthermore, a secondary product gas line 150 is connected to the first connecting line 131, which is also provided for removing or discharging a secondary product gas flow 151 alternately from the first adsorption unit 110 or from the second adsorption unit 120. A product gas line 160 adjoins the second connecting line 132, which is provided for removing or discharging a product gas flow 161 alternately from the first adsorption unit 110 or from the second adsorption unit 120. The product gas line 160 opens into the vortex tube 200 or the vortex tube 200 is arranged in the product gas line 160 and a gas inlet 210 of the vortex tube 200 is connected to the product gas line 160. The gas inlet 210 is preferably arranged radially or tangentially to the longitudinal axis of the vortex tube 200. The vortex tube 200 additionally comprises a cold gas outlet 220 and a hot gas outlet 230, which are arranged axially opposite to one another and are associated with the respective ends of the vortex tube 200.

The method control of a pressure swing adsorption is to be explained in greater detail on the basis of the arrows included in FIG. 1a, wherein the first adsorption unit 110 of the inertizing installation 100 is in a desorption and/or regeneration phase (DES) and the second adsorption unit 120 is an adsorption phase (ADS). For this purpose, the second absorption unit 120 is pressurized and is fluidically connected to the gas mixture line 140. A gas mixture flow 141, in particular ambient air, which includes a reactive gas component, preferably the oxygen contained in the ambient air, and an inert gas component, preferably the nitrogen contained in the ambient air, is supplied via the gas mixture line 140 to the second adsorption unit 120. In particular, the gas mixture flow 141 can be introduced under pressure into the second absorption unit 120, whereby this unit is subjected to the pressure required for the absorption. Within the second adsorption unit 120, the reactive gas component contained in the gas mixture flow 141, in particular the oxygen, adsorbs on the adsorbent and is thus separated from the remaining non-absorbed and/or non-absorbing components, in particular the inert gas component or nitrogen. While the second adsorption unit 120 is in the adsorption phase, it is fluidically connected to the product gas line 160, so that the non-adsorbed and/or non-adsorbing components, in particular the inert gas component or nitrogen of the gas mixture flow 141, are removable via the product gas line 160 as the product gas flow 161. To introduce the product gas flow 161 into the vortex tube 200, the product gas line 160 opens into the vortex tube 200 or the product gas line 160 is fluidically connected to a gas inlet 210 of the vortex tube 200.

The first adsorption unit 110 is in the desorption and/or regeneration phase at this time and therefore has a pressure which is lower than the pressure applied in the second adsorption unit 120. Due to the pressure reduction during the desorption and/or regeneration phase, the reactive gas component, preferably oxygen, which has adsorbed on the adsorbent in a preceding adsorption phase, desorbs and can be removed and discharged as the secondary product gas flow 151 via the secondary product gas line 150. The secondary product gas line 150 is fluidically connected to the first adsorption unit 110 for this purpose. The product gas flow 161 removed in the absorption phase has an inert gas component, in particular a nitrogen proportion, increased over the gas mixed flow 141 and the secondary product gas flow 151 removed in the desorption phase has a reactive gas component, in particular an oxygen proportion, increased over the gas mixed flow 141.

The product gas flow 160 is removed from the pressurized second adsorption unit 120 and preferably introduced radially or tangentially under pressure via the gas inlet 210 into the vortex tube 200. The product gas flow 160 is divided into a cold product gas partial flow 162 and a hot product gas partial flow 163 within the vortex tube 200. The hot product gas partial flow 163 can be removed at the axially arranged hot gas outlet 230 and is warmer, thus has a higher temperature, than the product gas flow 160 introduced into the vortex tube 200. The cold product gas partial flow 162 can be removed at the axially opposite cold gas outlet 210 and is colder, thus has a lower temperature, than the product gas flow 160.

In this so-called pressure swing adsorption, cyclic switching takes place between the adsorption phase and the desorption and/or regeneration phase within each adsorption unit 110, 120. The adsorption units 110, 120 are connected in parallel, so that alternately the second adsorption unit 120 passes through an absorption phase, while the first adsorption unit 110 is in the desorption and/or regeneration phase. As soon the presently adsorbing adsorbent is in its saturation range or approaches its saturation range, a changeover takes place and the second adsorption unit 120 passes through a desorption and/or regeneration phase whereas an adsorption phase is initiated within the first adsorption unit 110.

A pressure equalization phase is carried out between each change, the method control of which is explained in greater detail on the basis of FIG. 1b and the arrows shown therein. FIG. 1b shows the exemplary embodiment of the inertizing installation 100 according to the invention having a vortex tube 200 from FIG. 1a having identical installation components, because of which they are not described in greater detail hereinafter. To carry out the pressure equalization phase, the first adsorption unit 110 and the second adsorption unit 120 are fluidically connected to one another, wherein the gas mixture flow 141 flows or circulates between the two adsorption units 110, 120 to equalize the pressure applied within the first adsorption unit 110 and within the second adsorption unit 120. FIG. 1b shows the pressure equalization phase, which follows an adsorption phase of the second adsorption unit 120 and a desorption and/or regeneration phase of the first adsorption unit 110. The gas mixture flow 141 leaves the second adsorption unit via its second line fitting 122, flows through the second connecting line 132, and enters the first adsorption unit 110 via the second line fitting 112. The gas mixture flow 141 can enter the first connecting line 131 via the first line fitting 111 and flow to the first line fitting 121 of the second adsorption unit 120. To fluidically connect the two adsorption units 110, 120 to one another, the connecting lines 131, 132 are opened, for example via control valves, whereas the fluidic connections to the gas mixture line 140, the secondary product gas line 150, and the product gas line 160 are disconnected, preferably also via control valves.

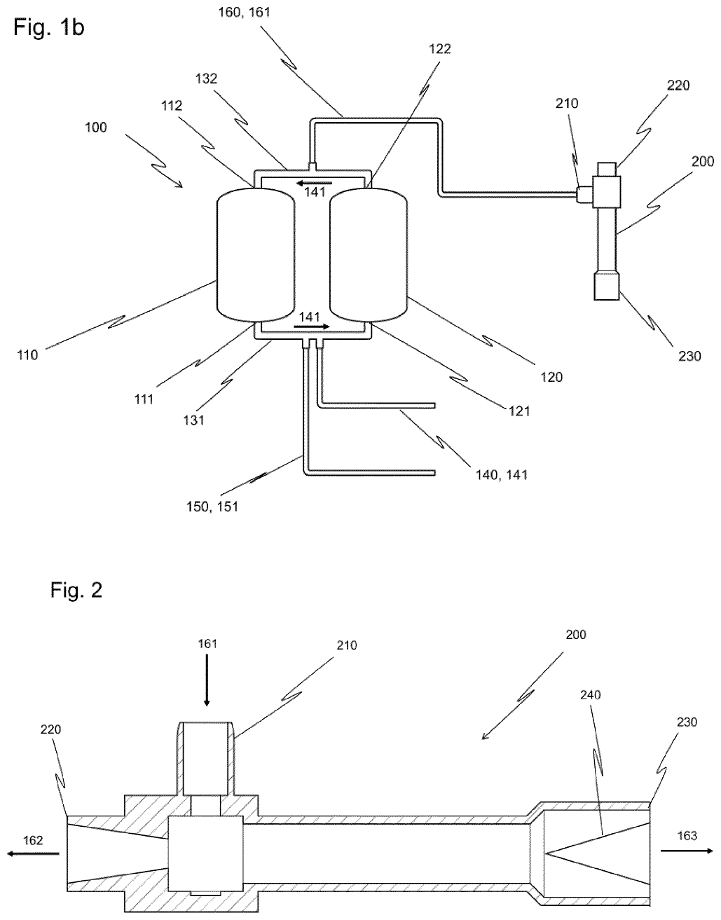

FIG. 2 shows a schematic sectional illustration of a vortex tube 200 known from the prior art, which according to the invention is a component of the exemplary embodiment of the inertizing installation 100 according to the invention from FIGS. 1a and 1b. The vortex tube 200 is essentially cylindrical and comprises a gas inlet 210, which radially adjoins the vortex tube 200 and is designed for the tangential introduction of the pressurized product gas flow 161 into the interior of the vortex tube 200. The product gas flow 161 is set into rapid rotation within the vortex tube 200, wherein the radial outer region of the swirled product gas flow 161 has a higher temperature and forms the hot product gas partial flow 163. The radial inner region of the swirled product gas flow 161 has a lower temperature and forms the cold product gas flow 162. A cold gas outlet 220 for removing the cold product gas partial flow 162 is arranged at one axial end of the vortex tube 200. A hot gas outlet 230 for removing the hot product gas partial flow 163 is arranged at the opposite axial end of the vortex tube 200. A setting means 240, in particular a control valve, for setting the temperature difference between the hot product gas partial flow 163 and the cold product gas partial flow 162 is provided within the vortex tube 200, associated with the hot gas outlet 230.

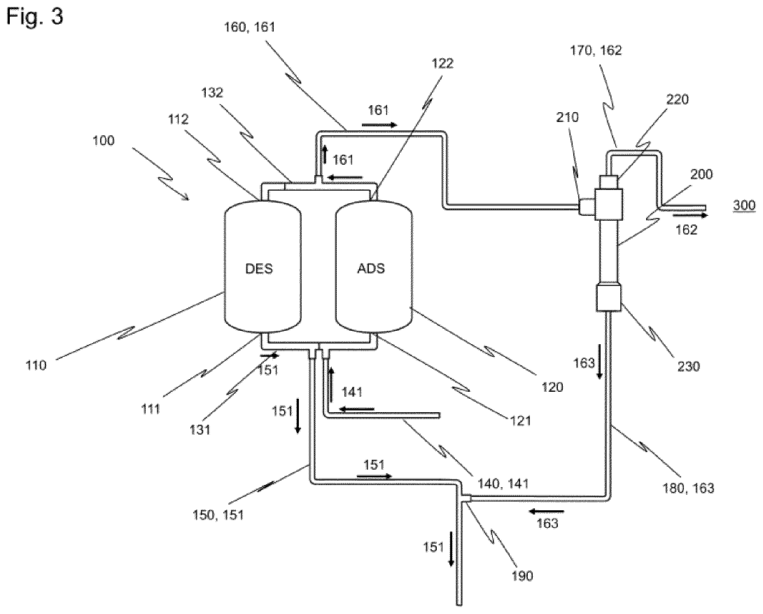

FIG. 3 shows an exemplary embodiment of an inertizing installation 100 according to the invention for carrying out a first method variant. The inertizing installation 100 shown in FIG. 3 has essentially identical installation components to the inertizing installation 100 as shown in FIGS. 1a and 1b, because of which these are not described in greater detail. In addition, the cold gas outlet 220 of the vortex tube 200 is connected to a cold gas line 170 for removing the cold product gas partial flow 162 and introducing it into an environment 300 to be inertized. For this purpose, the cold gas line 170 establishes a fluidic connection between the vortex tube 200 or between its cold gas outlet 220 and the environment 300. The environment 300 is, for example, a refrigerated environment, in particular a deep-freeze warehouse, which is inertized and simultaneously cooled by means of the cold, nitrogen-enriched product gas partial flow 162. The hot gas outlet 230 of the vortex tube 200 is connected to a hot gas line 180, which is provided for removing and conveying the hot product gas partial flow 163. The hot gas line 180 is connected to the secondary product gas line 150, preferably via a check valve 190, or opens into the secondary product gas line 150, so that the hot product gas partial flow can be introduced into the secondary product gas flow 151 for its dilution and is conveyed further as its component. Due to the introduction of the hot product gas partial flow 163 into the secondary product gas flow 151, its fluid group may be changed from fluid group 1 (hazardous, oxidizing) into fluid group 2 (harmless), in particular the included reactive gas component or oxygen proportion is reduced, whereby the oxidizing properties of the oxygen-enriched secondary product gas flow 151 are reduced and thus the demands on the line system provided for guiding the secondary product gas flow 151 or on the equipment provided for storing and/or disposing of the secondary product gas are reduced. Due to this first method variant, an environment 300, in particular a refrigerated environment or deep-freeze warehouse, can be inertized and cooled simultaneously by means of the cold, nitrogen-enriched product gas partial flow 162, while the oxygen-enriched secondary product gas flow 151 can be diluted by the hot product gas partial flow 163 and in this way its oxidizing properties can be reduced.

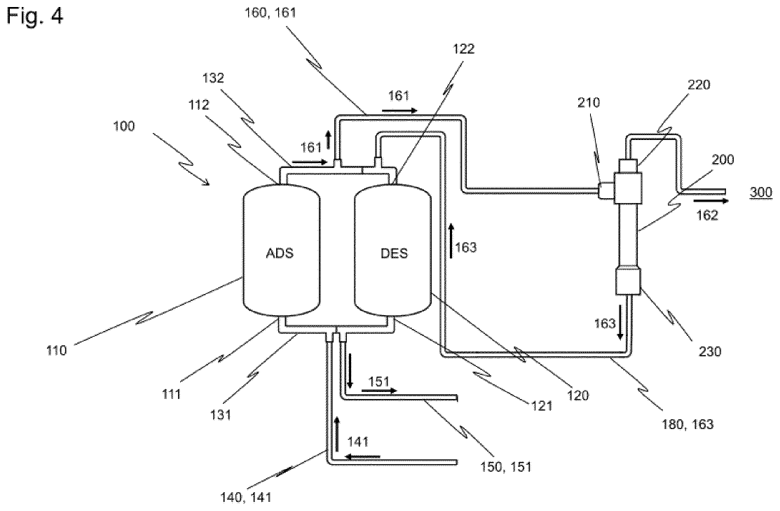

FIG. 4 shows an exemplary embodiment of an inertizing installation 100 according to the invention for carrying out a second method variant. The inertizing installation 100 shown in FIG. 4 differs from the inertizing installation 100 shown in FIG. 3 in that here, just the opposite, the first adsorption unit 110 of the inertizing installation 100 is in an adsorption phase (ADS) and is fluidically connected to a gas mixture line 140 and the product gas line 160. The second adsorption unit 120 is therefore in a desorption and/or regeneration phase (DES) and is fluidically connected to a secondary product gas line 150 and to a hot gas line 180. The remaining installation components correspond to the inertizing installation 100 shown in FIG. 3 and are therefore not explained in detail. The hot gas line 180 is connected to the hot gas outlet 230 of the vortex tube 200 and is provided for removing and guiding the hot product gas partial flow 163. To supply the hot product gas partial flow 163 indirectly to the respective adsorption unit 110, 120 in the desorption phase, the hot gas line 180 opens into the second connecting line 132 or alternatively into the first connecting line 131 (not shown), so that the hot product gas partial flow 163 is supplied, in particular during the pressure swing phase, as a component of the gas mixture flow 141 to the corresponding adsorption unit 110, 120. The hot product gas partial flow 163 then contributes as a component of the gas mixture flow 141 to the regeneration of the adsorbent, in that the thermal energy transferred directly to the gas mixture flow 141 increases the efficiency of the regeneration or facilitates the desorption.

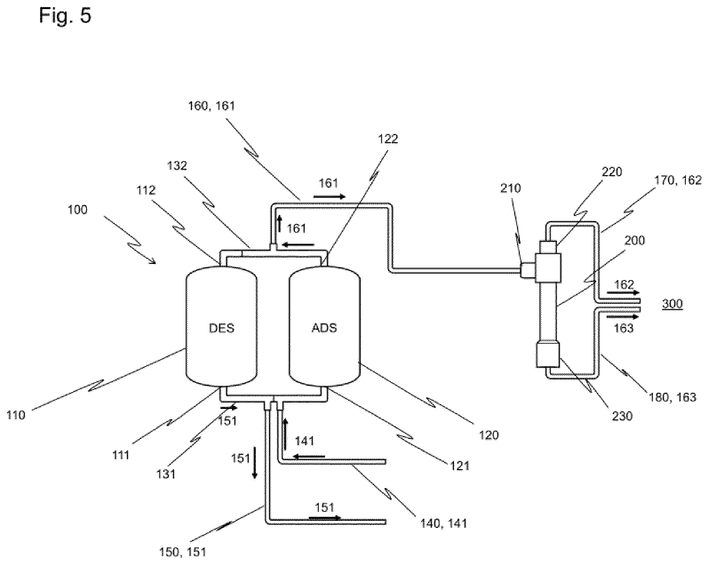

Carrying out a third method variant is shown in the exemplary embodiment of an inertizing installation 100 according to the invention shown in FIG. 5. The inertizing installation 100 shown in FIG. 5 also essentially corresponds to the inertizing installation 100 shown in FIGS. 3 and 4 and again differs due to the hot gas line 180. This line adjoins the hot gas outlet 230 of the vortex tube 200 and is fluidically connected to the environment 300 to be inertized, like the cold gas line 170, or the hot gas line 180 opens into the environment 300. Alternatively, it is also conceivable that the cold product gas partial flow 162 removed from the vortex tube 200 and the hot product gas partial flow 163 removed from the vortex tube 200 are combined completely or partially to form a mixed product gas flow and this mixed product gas flow is introduced into the environment 300. A regulated temperature control of the environment 300 can be carried out in that the two product gas partial flows 162, 163 are only supplied partially, in different components, to the environment 300. At the same time, by introducing both product gas partial flows 162, 163, faster inertizing of the environment 300 can take place or the oxygen proportion present in the environment 300 can be replaced and/or exchanged or displaced faster.

The above-described line connections shown in respective FIGS. 3-5 are advantageously connected so they can be switched or disconnected and/or controlled in particular via control valves in order to fluidically connect corresponding installation components to one another or to disconnect or regulate an existing fluidic connection. In this way, it is possible to combine the individual method variants flexibly with one another as needed, wherein the individual gas flows can be supplied completely or partially and at least temporarily to the provided installation components, lines, or the environment.

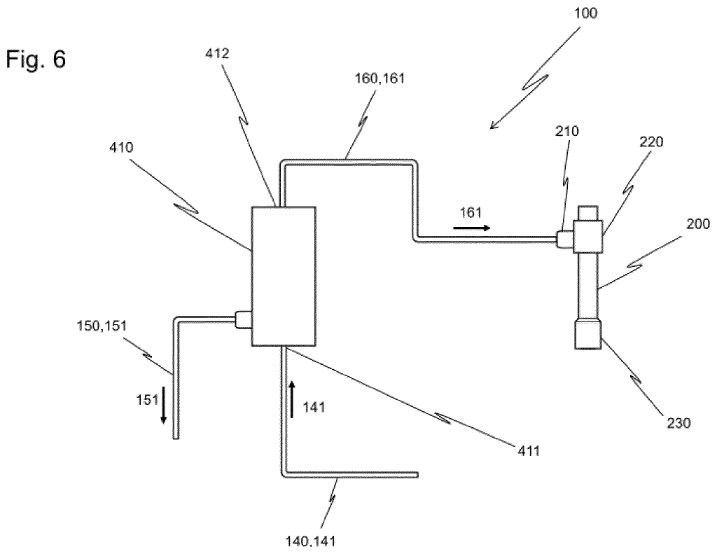

FIG. 6 shows an exemplary embodiment of an inertizing installation 100 according to the invention which is suitable for carrying out a membrane method. Like the above-described embodiments of the inertizing installations 100 according to the invention, the inertizing installation 100 illustrated in FIG. 6 comprises a gas mixture line 140, a secondary product gas line 150, and a product gas line 160, wherein the latter opens into the vortex tube 200 or is connected to a gas inlet 210 of the vortex tube. In contrast to the above-described embodiments, instead of the two adsorption units 110, 120, a single, tubular membrane module 410 is provided and is connected to the gas mixture line 140, the secondary product gas line 150, and also the product gas line 160. The membrane module 410 is capable of continuously separating the gas mixture flow 141 supplied in the gas mixture line 140 and contains in its interior a plurality of hollow fiber membranes arranged coaxially to one another and to the membrane module 410. A separation means for producing a diffusion layer is applied to the outer surface of the hollow fiber membranes, through which the reactive gas component contained in the gas mixture flow 141, in particular oxygen, and also water vapor diffuse rapidly. In contrast, the inert gas component, in particular nitrogen, has a low diffusion speed with respect to the separation means and is therefore held back by the diffusion layer formed.

By means of the gas mixture line 140, the gas mixture flow 141 is introduced centrally into the membrane module via a first longitudinal end 411 of the membrane module 410 under pressure application and at the same time flows in the interior of the hollow fiber membranes arranged inside the membrane module 410. While the reactive gas component diffuses radially through the walls of the hollow fiber membranes, the inert gas component is largely held in the fiber interior and can be removed at a second longitudinal end 412 of the membrane module 410 arranged opposite to the first longitudinal end 411 via the product gas line 160 connected there as the product gas flow 161. The diffused reactive gas component enriches in the radial outer region of the membrane module 410, in contrast, and may be removed via the radially connected secondary product gas line 150 as the secondary product gas flow 151. The removed product gas flow 161 is supplied, as usual, to the vortex tube 200 for its temperature-dependent division.

It is provided according to the invention that the above-described advantageous method variants are to be applied if possible to arbitrary gas separation methods, in particular to the membrane method illustrated in FIG. 6.

Overall, the different exemplary embodiments of the inertizing installation 100 according to the invention and the inertizing method carried out enable improved and more efficient inertizing of a temperature-controlled environment 300 and additional possible uses of the product gas flow 161 are provided. For example, by introducing the hot product gas partial flow 163 and/or the cold product gas flow 162 into the environment 300, costs for its temperature control can be saved. Alternatively or simultaneously, the hot product gas partial flow 163 can be introduced into the secondary product gas flow to dilute the oxygen-enriched secondary product gas flow 151 in order to reduce its oxidizing properties.

### LIST OF REFERENCE NUMERALS

100 inertizing installation
110 gas separation unit, first adsorption unit
111 first line fitting of the first adsorption unit
112 second line fitting of the first adsorption unit
120 gas separation unit, second adsorption unit
121 first line fitting of the second adsorption unit
122 first line fitting of the second adsorption unit
131 first connecting line
132 second connecting line
140 gas mixture line
141 gas mixture flow
150 secondary product gas line
151 secondary product gas flow
160 product gas line
161 product gas flow
162 cold product gas partial flow
163 hot product gas partial flow
170 cold gas line
180 hot gas line
190 check valve
200 vortex tube
210 gas inlet
220 cold gas outlet
230 hot gas outlet
240 setting means
300 environment
410 gas separation unit, membrane module
411 first longitudinal end
412 second longitudinal end

1. An inertizing method for inertizing an environment (300), wherein a product gas flow (161) is produced starting from a gas mixture flow (141) and introduced into the environment (300), which gas mixture flow (141) contains at least one reactive gas component which is reactive under the predetermined ambient conditions and an inert gas component which is inert under the predetermined ambient conditions, wherein
the gas mixture flow (141) is supplied to at least one gas separation unit (110, 120, 410) with application of pressure and the reactive gas component is at least partially separated from the gas mixture flow (141) by means of a separating means,
gas components which are not separated and/or not separable from the gas mixture flow (141) are removed from the at least one gas separation unit (110, 120, 410) as the product gas flow (161), and
the reactive gas components separated from the gas mixture flow (141) are removed from the at least one gas separation unit (110, 120, 410) as a secondary product gas flow (151),
characterized in that
introducing into a vortex tube (200) the product gas flow (161) removed from the at least one gas separation unit (110, 120, 410),
dividing or separating the product gas flow (161) into a cold product gas partial flow (162) and a hot product gas partial flow (163) within the vortex tube (200), and subsequently
completely or partially or temporarily introducing into the environment (300) the hot or cold product gas flow (162, 163).

2. The inertizing method according to claim 1,
characterized in that
the cold product gas partial flow (162) is introduced completely or partially or temporarily into the environment (300), wherein the environment (300) is inertized by means of the cold product gas partial flow (162) and the cold product gas partial flow (162) simultaneously contributes to cooling the environment (300).

3. The inertizing method according to claim 1,
characterized in that
the hot product gas partial flow (163) is introduced completely or partially or temporarily into the secondary product gas flow (151) removed from at least one gas separation unit (110, 120, 410).

4. The inertizing method according to claim 1,
characterized in that
the hot product gas partial flow (163) is supplied completely or partially or temporarily to at least one gas separation unit (110, 120, 410).

5. The inertizing method according to claim 1,
characterized in that
the hot product gas partial flow (163) is introduced completely or partially and/or temporarily into the environment (300), wherein the environment (300) is inertized by means of the hot product gas partial flow (163) and the hot product gas partial flow (162) simultaneously contributes to heating the environment (300).

6. The inertizing method according to claim 1,
characterized in that
the cold product gas partial flow (162) removed from the vortex tube (200) and the hot product gas partial flow (163) removed from the vortex tube (200) can be combined completely or partially and/or temporarily to form a mixed product gas flow and this mixed product gas flow can be supplied to an environment (300), wherein the environment (300) is inertized by means of the mixed product gas flow.

7. The inertizing method according to claim 1,
characterized in that
the product gas flow (161) is at least partially condensed within the vortex tube (200) and the condensate is separated.

8. The inertizing method according to claim 1,
characterized in that
ambient air is used as a gas mixture flow (141), wherein the reactive gas component is oxygen and the inert gas component is nitrogen.

9. An inertizing installation (100) for producing and providing a product gas flow (161) which is inert, in particular poorly-flammable under predetermined ambient conditions present in the environment (300), comprising one or more gas separation units (110, 120, 410), each gas separation unit having
a line connection and is fluidically connectable to a gas mixture line (140) for supplying a gas mixture flow (141), wherein the gas mixture flow (141) contains at least one reactive gas component which is reactive under the predetermined ambient conditions and an inert gas component which is inert under the predetermined ambient conditions,
a separating means suitable for separating the reactive gas component from the gas mixture flow (141) and can be pressurized to separate the reactive gas component from the gas mixture flow (141),
a line connection and is fluidically connectable to a product gas line (160) for removing a product gas flow (161), wherein the product gas flow (161) contains gas components which are not separated or not separable from the gas mixture flow (141) and the product gas line (161) has a line connection to the environment (300) for introducing the product gas flow (161), and
a line connection and is are fluidically connectable to a secondary product gas line (150) for removing a secondary product gas flow (151), wherein the secondary product gas flow (151) contains the reactive gas components separated from the gas mixture flow (141),
characterized in that
the inertizing installation (100) has a vortex tube (200), which is arranged in the product gas line (160), wherein the product gas line (160) opens into the vortex tube (200) to introduce the product gas flow (161) removed from the one or the multiple gas separation units (110, 120, 410), and wherein the vortex tube (200) is designed for temperature-dependent separation or division of the product gas flow (161) and has a cold gas outlet (220) for removing and providing a cold product gas partial flow (162) and a hot gas outlet (230) for removing and providing a hot product gas partial flow (163).

10. The inertizing installation (100) according to claim 9,
characterized in that
the cold gas outlet (220) or the hot gas outlet (230) of the vortex tube (200) has a line connection and is fluidically connectable to the environment (300), so that the cold product gas partial flow (162) or the hot product gas partial flow (163) can be introduced into the environment (300) for inertizing thereof.

11. The inertizing installation (100) according to claim 9,
characterized in that
the hot gas outlet (230) of the vortex tube (200) has a line connection and is fluidically connectable to a connecting line (131, 132) of the inertizing installation, so that the hot product gas partial flow (163) can be introduced into the connecting line (131, 132).

12. The inertizing installation (100) according to claim 9,
characterized in that
the hot gas outlet (230) of the vortex tube (200) has a line connection and is fluidically connectable to the secondary product gas line (150), so that the hot product gas partial flow (163) can be introduced into the secondary product gas line (150).

13. The inertizing installation (100) according to claim 9,
characterized in that
the vortex tube (200) has a condensate trap for separating condensate arising during the separation and/or division of the product gas flow (161).

14. The inertizing installation (100) according to claim 9,
characterized in that
the vortex tube (200) has a setting means (240) for setting the temperature difference between the hot product gas partial flow (163) and the cold product gas partial flow (162).

15. A method for using an inertizing installation (100) according to claim 9 for inertizing and cooling a refrigerated environment (300), the inertizing installation (100) producing and providing an inert product gas flow (161), and having one or more gas separation units (110, 120, 410), which have a line connection to a product gas line (160) for removal of the product gas flow (161), wherein the product gas line (160) has a line connection to the refrigerated environment (300) for the introduction of the product gas flow (161),
characterized in that
the product gas flow (161) is introduced into a vortex tube (200) and is divided within the vortex tube (200) into a hot product gas partial flow (163) and a cold product gas partial flow (162) and subsequently the cold product gas partial flow (162) is introduced completely or partially into the refrigerated environment (300).
